(19) United States
(12) Patent Application Publication
(10) Pub. No.: US 2014/0182132 A1
(43) Pub. Date: Jul. 3, 2014

(54) METHOD OF MANUFACTURING A VAPOR CHAMBER STRUCTURE

(71) Applicant: ASIA VITAL COMPONENTS CO., LTD., New Taipei City (TW)

(72) Inventor: Chih-Peng Chen, New Taipei City (TW)

(73) Assignee: ASIA VITAL COMPONENTS CO., LTD., New Taipei City (TW)

(21) Appl. No.: 13/732,420

(22) Filed: Jan. 1, 2013

(51) Int. Cl. B23P 15/26

(52) U.S. Cl. CPC B23P 15/26
USPC 29/890.03

(57) ABSTRACT

A vapor chamber structure includes an integrally formed main body defining a chamber and having radiating fins. The radiating fins are outward extended from one side of the main body in a direction opposite to the chamber; the chamber is internally provided with a wick structure and filled with a working fluid. A method of manufacturing a vapor chamber structure is also disclosed, which includes the steps of using an extrusion process to manufacture a main body having a plurality of radiating fins and a chamber; forming at least one wick structure on inner walls of the chamber after the main body has been manufactured; and sealing two ends of the main body, and evacuating the chamber before filling it with a working fluid. With the method, the vapor chamber structure can be manufactured with reduced material and labor costs and shortened manufacturing time.

### FIELD OF THE INVENTION

The present invention relates to a method of manufacturing a vapor chamber structure, and more particularly to a manufacturing method for forming a vapor chamber structure by way of extrusion, so that the vapor chamber structure has a sealed chamber and a plurality of outward extended radiating fins integrally formed with one another.

### BACKGROUND OF THE INVENTION

Due to the rapid progress in different technological fields, most of the currently available electronic products have largely enhanced functions, and many internal electronic elements of these functionally enhanced electronic products, such as the central processing unit (CPU), the chipset, or the display unit thereof, also have constantly increased operating speed. The electronic elements operating at high speed would produce more heat in one unit time. The produced heat must be timely removed with proper means, so as to avoid lowered stability and performance of the electronic products or even burnout of the electronic elements.

The heat dissipation devices generally adopted by the electronic industry for removing heat from the electronic elements include fans, heat sinks and heat pipes. The heat sink is provided to contact with a heat source for absorbing heat, and the absorbed heat is then transferred to a remote location by a heat pipe for dissipating into ambient air. The fan is used to force air flow through the heat sink to carry the absorbed heat away from the heat sink. For a heat source that is located in a considerably narrow space or has a considerably large area, a vapor chamber is usually selected as the heat dissipation element for heat transfer and heat dissipation.

A conventional vapor chamber is formed by closing two mating plates to each other, so as to define a sealed chamber between the two closed plates. The sealed chamber is in a vacuum state and has a supporting structure and a wick structure provided therein. The wick structure for the conventional vapor chamber can be a mesh structure, a sintered-powder structure or a plurality of grooves, and is formed, in a secondary processing, on one side of the plate that is to be closed by the other plate. After the two plates are closed together, air enclosed in the sealed chamber is evacuated to produce a vacuum state in the chamber, and then the chamber is filled with a working fluid. When forming the conventional vapor chamber through the above procedures, a lot of labor, time and material are required.

In conclusion, the prior art vapor chamber has the following disadvantages: (1) requiring higher manufacturing cost; and (2) requiring longer manufacturing time.

It is therefore tried by the inventor to develop an improved vapor chamber structure and a method of manufacturing same that eliminate the disadvantages in the prior art vapor chamber.

### SUMMARY OF THE INVENTION

A primary object of the present invention is to provide a vapor chamber structure that is manufactured with reduced labor cost and shortened manufacturing time.

Another object of the present invention is to provide a method of manufacturing a vapor chamber structure with reduced labor cost and shortened manufacturing time.

To achieve the above and other objects, the vapor chamber structure according to the present invention includes a main body internally defining a sealed chamber and having a plurality of radiating fins externally provided thereon. The radiating fins are integrally formed on and outward extended from one side of the main body in a direction opposite to the chamber; and the chamber is internally provided with a wick structure and filled with a working fluid.

To achieve the above and other objects, the method of manufacturing a vapor chamber structure according to the present invention includes the steps of an using an extrusion process to manufacture a main body having a plurality of radiating fins and a chamber; and sealing two opposite open ends of the main body and evacuating the chamber before filling the chamber with a working fluid.

According to the present invention, a vapor chamber structure is integrally formed by way of extrusion to have a sealed chamber and a plurality of outward extended radiating fins. In this way, the vapor chamber structure can be manufactured with reduced material and labor as well as shortened manufacturing time to largely lower the overall manufacturing cost thereof

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1A is a perspective sectional view of a first embodiment of a vapor chamber structure according to the present invention;

FIG. 1B is a cross sectional view of the vapor chamber structure of FIG. 1A;

FIG. 2 is a cross sectional view of a second embodiment of the vapor chamber structure according to the present invention;

FIG. 3 is a cross sectional view of a third embodiment of the vapor chamber structure according to the present invention;

FIG. 4A is a perspective sectional view of a fourth embodiment of the vapor chamber structure according to the present invention;

FIG. 4B is a cross sectional view of the vapor chamber structure of FIG. 4A;

FIG. 5 is a flowchart showing the steps included in a first embodiment of a method of manufacturing a vapor chamber structure according to the present invention;

FIG. 6 is a flowchart showing the steps included in a second embodiment of the method of manufacturing a vapor chamber structure according to the present invention; and

FIG. 7 is a flowchart showing the steps included in a third embodiment of the method of manufacturing a vapor chamber structure according to the present invention.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

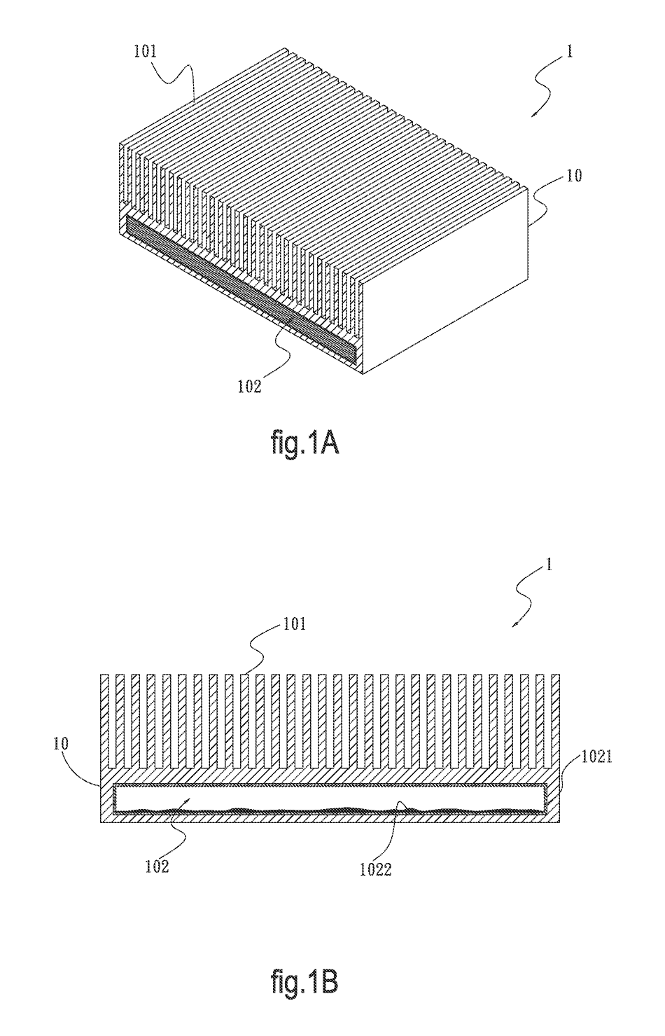

Please refer to FIGS. 1A and 1B that are perspective sectional and cross sectional views, respectively, of a first embodiment of a vapor chamber structure 1 according to the present invention. As shown, the vapor chamber structure 1 in the first embodiment includes a main body 10, which defines a sealed chamber 102 and has a plurality of radiating fins 101 provided thereon. The radiating fins 101 are outward extended from one side of the main body 10 in a direction opposite to the chamber 102. The chamber 102 is internally provided with a wick structure 1021 and filled with a working fluid 1022.

The wick structure 1021 can be formed of a plurality of grooves, a sintered powder structure, or a mesh structure. In the first embodiment, the wick structure 1021 is illustrated as a plurality of grooves without limiting the present invention thereto.

In the present invention, the radiating fins 101 and the chamber 102 are integrally formed with one another.

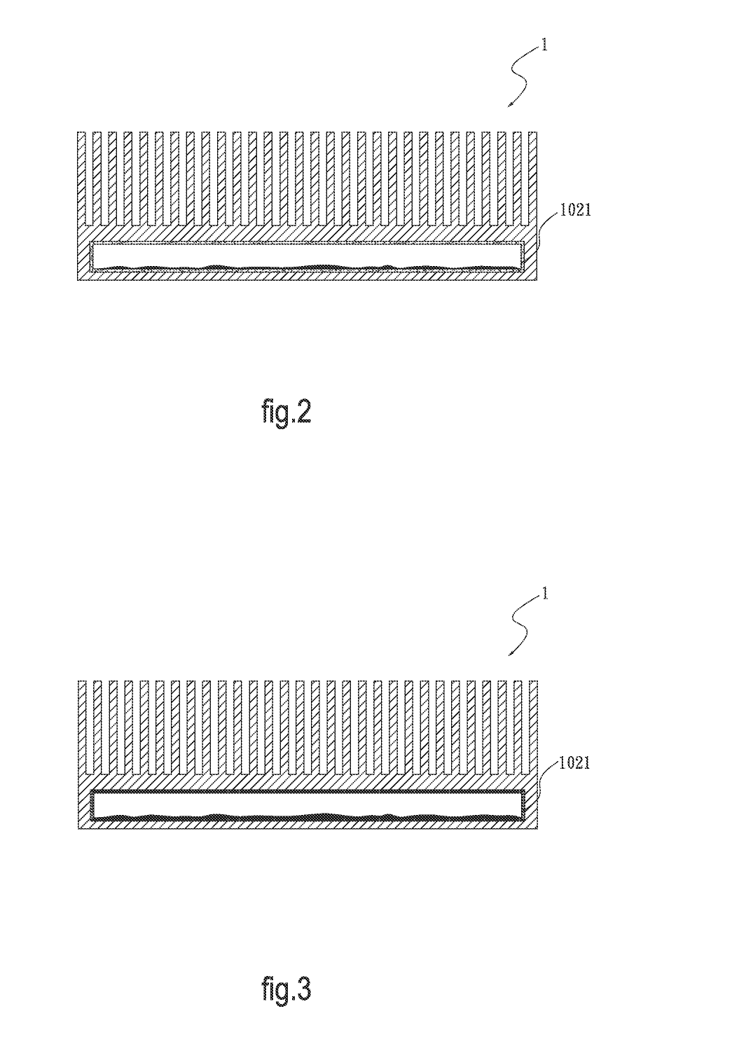

Please refer to FIG. 2 that is a cross sectional view of a second embodiment of the vapor chamber structure 1 according to the present invention. As shown, the vapor chamber structure 1 in the second embodiment is generally structurally similar to that in the first embodiment, except that the wick structure 1021 in the second embodiment is illustrated as a sintered-powder structure without limiting the present invention thereto.

FIG. 3 is a cross sectional view of a third embodiment of the vapor chamber structure 1 according to the present invention. As shown, the vapor chamber structure 1 in the third embodiment is generally structurally similar to that in the first embodiment, except that the wick structure 1021 in the third embodiment is illustrated as a mesh structure without limiting the present invention thereto.

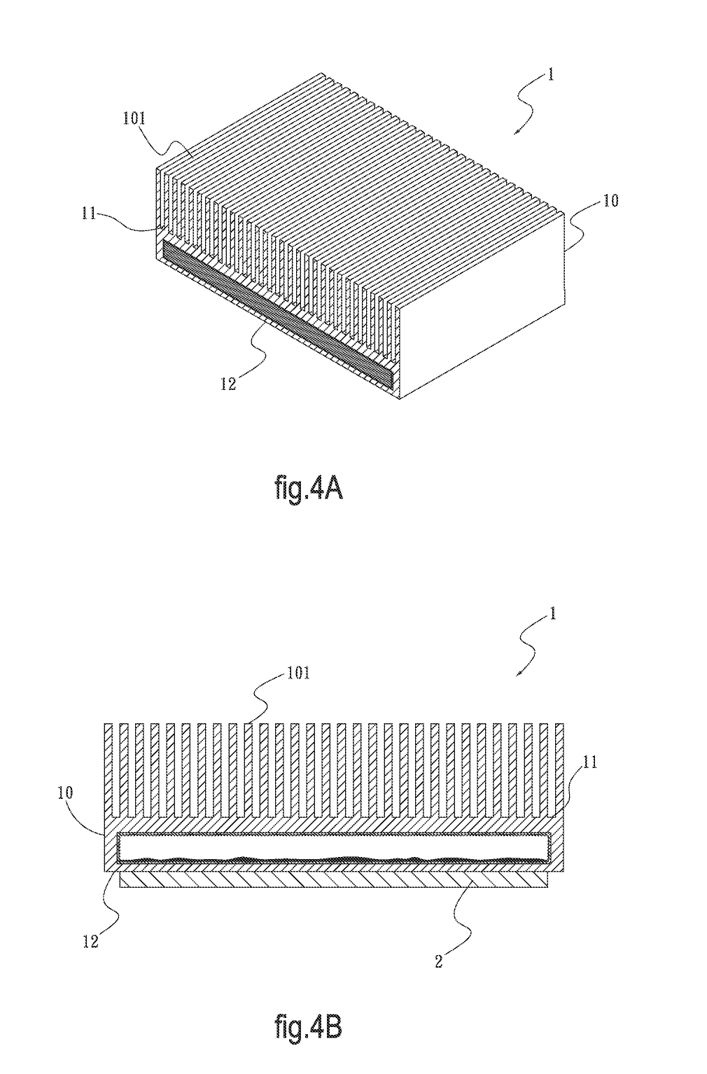

FIGS. 4A and 4B are perspective sectional and cross sectional views, respectively, of a fourth embodiment of the vapor chamber structure 1 according to the present invention. As shown, the vapor chamber structure 1 in the fourth embodiment is generally structurally similar to that in the first embodiment, except that the main body 10 in the fourth embodiment includes a first side 11 and an opposite second side 12. The radiating fins 101 can be selectively formed on the first side 11 or the second side 12 to outward extend therefrom, while the other side of the main body 10 without the radiating fins 101 is for contacting with a heat source 2.

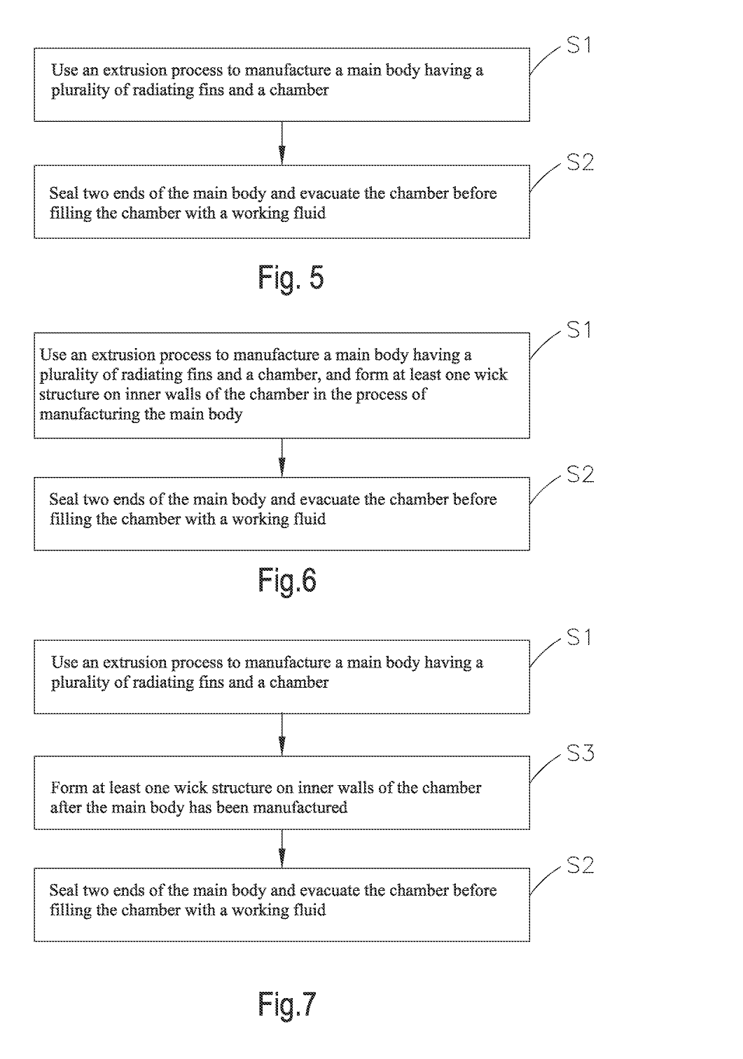

FIG. 5 is a flowchart showing steps S1 and S2 included in a first embodiment of a method of manufacturing a vapor chamber structure according to the present invention. Please refer to FIG. 5 along with FIG. 1B.

In the step S1, a main body is manufactured using an extrusion process to have a plurality of radiating fins and a chamber.

More specifically, a main body 10 is integrally formed using an extrusion process to have a plurality of radiating fins 101 and a chamber 102.

In the step S2, two opposite open ends of the main body are sealed, and the chamber is evacuated before being filled with a working fluid.

More specifically, two opposite open ends of the main body 10 are sealed, and the chamber 102 is evacuated before being filled with a working fluid 1022.

FIG. 6 is a flowchart showing steps S1 and S2 included in a second embodiment of the method of manufacturing a vapor chamber structure according to the present invention. Please refer to FIG. 6 along with FIG. 1B.

The step S1 included in the second embodiment is partially the same as the step S1 in the first embodiment in that a main body is manufactured using an extrusion process to have a plurality of radiating fins and a chamber. However, according to the second embodiment, the step S1 further includes a step of forming at least one wick structure on inner wall surfaces of the chamber in the process of manufacturing the main body.

More specifically, a main body 10 is integrally formed using an extrusion process to have a plurality of radiating fins 101 and a chamber 102, and at least one wick structure 1021 is formed on inner wall surfaces of the chamber in the process of manufacturing the main body 10. The wick structure 1021 can include a plurality of grooves.

Since the step S2 in the second embodiment of the vapor chamber structure manufacturing method of the present invention is identical to that in the first embodiment, it is not repeatedly described herein.

FIG. 7 is a flowchart showing steps S1, S3 and S2 included in a third embodiment of the method of manufacturing a vapor chamber structure according to the present invention. Please refer to FIG. 7 along with FIG. 1B. As shown, the method of the present invention in the third embodiment has a step S1 and a step S2 identical to those in the first embodiment. However, in the third embodiment, after the first step S1, there is a further step S3, in which at least one wick structure is formed on inner walls of the chamber after the main body has been manufactured.

More specifically, in the step S3, at least one wick structure 1021 is formed on inner walls of the chamber 102 after the main body 10 has been manufactured, and the wick structure 1021 can be a sintered-powder structure or a mesh structure.

By integrally forming the radiating fins 101 and the chamber 102 with one another in manufacturing the vapor chamber structure 1, it is not necessary to assemble the radiating fins to the vapor chamber by welding or other additional mechanical processing. Therefore, with the method of the present invention, the manufacturing process of the vapor chamber structure 1 is effectively simplified to reduce the labor cost and the manufacturing time thereof.

In summary, compared to the prior art, the vapor chamber structure according to the present invention and the manufacturing method thereof have the following advantages: (1) enabling reduced manufacturing cost; and (2) enabling reduced labor cost and shortened manufacturing time.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A method of manufacturing a vapor chamber structure, comprising the following steps:
(a) using an extrusion process to manufacture a main body having a plurality of radiating fins and a chamber; and
(b) sealing two open ends of the main body, evacuating the chamber, and then filling the chamber with a working fluid.

2. The method of manufacturing a vapor chamber structure as claimed in claim 1, further comprising a step (c) after the step (a) for forming at least one wick structure on inner walls of the chamber after the main body has been manufactured.

3. The method of manufacturing a vapor chamber structure as claimed in claim 1, wherein the radiating fins and the chamber are integrally formed with one another.

4. The method of manufacturing a vapor chamber structure as claimed in claim 1, wherein, in the step (a), at least one wick structure is also formed on inner walls of the chamber in the process of manufacturing the main body.

5. The method of manufacturing a vapor chamber structure as claimed in claim 4, wherein the wick structure includes a plurality of grooves.

6. The method of manufacturing a vapor chamber structure as claimed in claim 2, wherein the wick structure is selected from the group consisting of a sintered-powder structure and a mesh structure.
